(19) United States
(12) Patent Application Publication
(10) Pub. No.: US 2020/0262255 A1
(43) Pub. Date: Aug. 20, 2020

(54) Tire-Pressure Monitoring Sensor Testing Tool

(71) Applicant: Robert Bosch GmbH, Stuttgart (DE)

(72) Inventors: Kevin Damm, Macomb, MI (US); Fred Kaleal, Grosse Pointe Woods, MI (US); William Wittliff, Gobles, MI (US)

(21) Appl. No.: 16/061,539

(22) PCT Filed: Nov. 11, 2016
(86) PCT No.: PCT/EP2016/077396

§ 371 Date: Jun. 12, 2018

Related U.S. Application Data
(60) Provisional application No. 62/269,672, filed on Dec. 18, 2015.

(51) Int. Cl. B60C 23/04

(52) U.S. Cl. CPC B60C 23/0479; B60C 23/0471; B60C 23/0433

(57) ABSTRACT

A tire pressure monitoring system testing tool includes a housing, an extender that protrudes from one end of the housing, and a signal emitter that disposed in a distal end of the extender. The signal emitter is configured to emit a low frequency radio frequency signal. The testing tool also includes a manually-operated activation switch that is supported on the housing and permits activation of the signal emitter. The extender is configured to provide a relatively large spacing between the switch and the signal emitter so as to permit a standing, upright user to hold the housing in one hand and to place the signal emitter at a ground-height location without requiring the user to bend at the waist or knee. In some embodiments, the length of the extender is in a range of two to twenty times the length of the housing.

### TECHNICAL FIELD

This disclosure relates to an ergonomic testing tool used with a tire pressure monitoring system (TPMS), and more particularly to a hand-held TPMS testing tool that includes a signal emitter that is configured to excite a tire pressure monitoring sensor and an extender that supports and retains the signal emitter at a predetermined distance from a manually-activated tool activation switch.

### BACKGROUND

A tire-pressure monitoring system (TPMS) is an electronic system designed to monitor air pressure inside a pneumatic tire on a vehicle and alert a vehicle operator when the air pressure in a tire is low. Because the TPMS helps to reduce operation of vehicles with improperly inflated tires, vehicle including the TPMS may be involved in fewer traffic accidents, avoid poor fuel economy, and have improved tire wear due to improperly inflated tires. A TPMS may be configured to deliver tire-pressure information to a driver of a vehicle, either via a gauge, a pictogram display, or a low-pressure warning light.

In some TPMSs, each tire includes a tire pressure sensor disposed, for example, at the base of the air valve. The tire pressure sensors are typically activated by a radio frequency signal having a frequency of less than about 30 MHz, and thus are referred to as low frequency (LF) signals. This can be compared to signals having a frequency greater than about 30 MHz that are typically referred to as radio frequency (RF) signals. To reduce system power requirements, the pressure sensor in each tire is normally off and only provides an output signal upon receipt of a request from a TPMS control unit. The output signal may include a detected pressure as well as a unique identifier that identifies the individual sensor. Upon initialization of the TPMS system, such as performed by the manufacturer, the location of each sensor (e.g., right front tire, right rear tire, left front tire or left rear tire) is mapped by the control unit so that any alert generated by the TPMS can identify which tire is improperly inflated. However, if the position of the tire is changed, for example during tire rotation or replacement, the TPMS must be updated to learn the new relationship between sensor signal and tire location. To this end, a hand-held tool known as a “TPMS testing tool” (FIG. 10) is used to activate the tire pressure sensor so that it emits a signal to the TPMS control unit. By using the TPMS testing tool to stimulate each tire individually in a manufacturer-prescribed pattern, the TPMS can “re-learn” the location of each sensor. Some TPMS testing tools are configured to emit a very short range (for example, approximately 0.2 meters) radio frequency signal so that a sensor within one tire can be excited without exciting the sensor of a neighboring tire. Due to the very short excitation signal range, the TPMS testing tool must be placed in close proximity to the tire valve in order to excite the sensor. Since the TPMS system may be updated while the vehicle, and thus the tires, are on the ground, users of the TPMS testing tool must frequently bend and/or move into awkward or uncomfortable postures in order to place the TPMS testing tool in the desired proximity to the sensor (FIG. 11). Thus, it would be desirable to have an ergonomically-friendly TPMS testing tool that would permit the user to place the TPMS testing tool in the proper location while remaining in a comfortable upright standing posture.

### SUMMARY

In some aspects, a tire pressure monitoring system testing tool includes a housing having a first end, a second end opposed to the first end, and a sidewall that extends between the first end and the second end. The sidewall together with the first end and the second end define a closed container, and the distance between the first end and the second end corresponds to a length of the housing. The testing tool includes an extender that protrudes from the first end. The extender has a proximal end connected to the first end and a distal end opposed to the proximal end. The distance between the proximal end and the distal end corresponds to a length of the extender. The testing tool also includes a signal emitter disposed in the distal end of the extender, the signal emitter configured to emit a radio frequency signal, an electronic control unit disposed in the testing tool, and a manually-operated activation switch that is supported on the sidewall and permits activation of the signal emitter. The length of the extender is in a range of two to twenty times the length of the housing.

The tire pressure monitoring system testing tool may include one or more of the following features: The length of the extender is adjustable. The extender is formed of individual segments that are configured to telescope with respect to one another. The extender is formed of individual segments that are configured to be assembled end-to-end to form an elongated rod. The extender is formed of individual segments that are configured to be assembled end-to-end to via a pivoting connections to form an elongated rod. The extender is a unitary flexible and elastic rod. The proximal end of the extender is formed integrally with the housing first end. The proximal end of the extender is connected to the housing first end via a detachable connector. The proximal end of the extender is connected to the housing first end via a bayonet connector. The proximal end of the extender is connected to the housing first end via a screw thread connection. The signal emitter comprises a low frequency coil that is electrically connected to, and controlled by, the electronic control unit. The signal emitter is configured to emit a radio frequency signal of less than 30 MHz. The signal emitter is configured to emit a radio frequency signal having a maximum range of 0.3 meters.

In some aspects, a tire pressure monitoring system testing tool includes a housing that is dimensioned to be held in a hand of a user, and an extender that protrudes from the housing. The extender includes a proximal end that is detachably connected to an end of the housing and a distal end opposed to the proximal end. The testing tool also includes a signal emitter disposed in the distal end of the extender that is configured to emit a radio frequency signal of less than 30 MHz, an electronic control unit disposed in the testing tool, and a manually-operated activation switch that is supported on a side of the housing and permits activation of the signal emitter. The extender is configured to permit a standing, upright user to hold the housing in one hand and to place the signal emitter at a ground-height location without requiring the user to bend at the waist or knee.

The tire pressure monitoring system testing tool may include one or more of the following features: The distance between the proximal end and the distal end corresponds to a length of the extender, and the length of the extender is adjustable. The extender is formed of individual segments that are configured to telescope with respect to one another. The extender is formed of individual segments that are configured to be assembled end-to-end to form an elongated rod. The proximal end of the extender is connected to the housing first end via a detachable connector.

In some aspects, a tire pressure monitoring system testing tool kit includes a housing that is dimensioned to be held in a hand of a user, a first extender including a proximal end that is configured to be detachably connected to an end of the housing and a distal end opposed to the proximal end, a second extender including a proximal end that is configured to be detachably connected to an end of the housing and a distal end opposed to the proximal end, the second extender being different from the first extender in one or more of shape, size, flexibility and material, a signal emitter disposed in the distal end of each of the first extender and the second extender, the signal emitter configured to emit a radio frequency signal of less than 30 MHz, an electronic control unit disposed in the testing tool, and a manually-operated activation switch that is supported on a side of the housing and permits activation of the signal emitter. The first and second extenders are each configured to permit a standing, upright user to hold the housing in one hand and to place the signal emitter at a ground-height location without requiring the user to bend at the waist or knee.

In some aspects, a tire pressure monitoring system testing tool includes a testing tool first end, a testing tool second end that is opposed to the first end, and a testing tool length that corresponds to a distance between the testing tool first end and the testing tool second end. The testing tool includes an electronic control unit disposed in the testing tool, and a signal emitter disposed at the testing tool second end, the signal emitter controlled by the electronic control unit and configured to emit a radio frequency signal. The testing tool also includes a manually-operated activation switch that is disposed at the testing tool first end, the activation switch switchable between an off position in which the signal emitter is not controlled by the electronic control unit to emit the radio frequency signal and an on position in which the signal emitter is controlled by the electronic control unit to emit the radio frequency signal, and an extender that is disposed between the activation switch and the signal emitter. The extender provides a predetermined spacing between the activation switch and the signal emitter, and the ratio of the predetermined spacing to the testing tool length is in a range of 0.50 to 0.99.

One aspect of this disclosure is directed to a TPMS testing tool that is used with TPMS systems made by different manufacturers. The testing tool is configured to activate a tire pressure monitoring (TPM) sensor that is located within a tire of a vehicle. The testing tool includes a housing that is shaped and dimensioned to be hand held. The housing stores the controller and other electronics that drive communication with the TPM sensor of a vehicle tire via signal emitter disposed outside the housing. A manually-operable switch is disposed on the housing that controls whether the testing tool emits an activation signal. The testing tool also includes an elongated extender that protrudes from the housing. A proximal end of the extender is connected to the housing, and the opposed distal end of the extender supports the signal emitter such as a low frequency (LF) coil configured to emit a low frequency radio frequency signal. The extender is provided in a length that permits a user to place the signal emitter of the TPMS testing tool in the proper location adjacent the tire valve of a vehicle tire while permitting the user to remain in a comfortable upright standing posture. By including the extender between the housing including the manually-operated switch and the signal emitter, it is possible for the user to avoid operating the testing tool while in an awkward, uncomfortable and/or physically distressful posture.

The TPMS testing tool including the extender is configured to minimize physical effort and discomfort, and hence maximize user efficiency. This can be compared to some conventional TPMS testing tools 20′ that do not include an extender (FIG. 10). Such conventional TPMS testing tools 20′ include a signal emitter 40′ that is mounted at one end of a housing 21′ that is sized and shaped to be held comfortably in one hand, and has an overall length that generally equal to or less than to the length of an average adult male hand. Although the conventional TPMS testing tools 20′ can be easily handled, the user must bend or crouch down in order to plate the signal emitter 40′ sufficiently close to the TPM sensor to activate it (FIG. 11). Moreover, the user must move into and out of this posture for each tire of the vehicle, and in some vehicle service centers, the user must repeat this operation for many vehicles in a single working day.

In some embodiments, the extender is an elongated rod that is formed integrally with the housing, while in other embodiments the extender is detachable from the housing. Providing a detachable extender has many advantages, including the ability to use different extenders with a single housing, where each extender is optimized for different applications. For example, one extender may allow a user to activate sensors and perform re-learn procedures without having to bend over to place the signal emitter at the air valve of the tire. Another extender may include a bend or be deformable to permit the user to activate sensors on an inner tire of dual-wheel vehicles. Yet another extender may be configured to permit activate of a sensor of a spare tire without having to remove the spare tire from the vehicle or to crawl under the vehicle.

A detachable extender further permits packaging and/or storage of the TPMS testing tool in a relatively smaller size than a testing tool formed with an integral extender. Moreover, in some embodiments the extender may be an assembly of interconnecting elements, which permits further reduction in packaging and/or storage size.

The above aspects of this disclosure and other aspects will be explained in greater detail below with reference to the attached drawings.

### BRIEF DESCRIPTION OF THE DRAWINGS

FIG. 1 illustrates a user standing upright and holding a housing of the TPMS testing tool in one hand while placing the tip of the tool adjacent the tire air valve and corresponding TPM sensor of a vehicle tire.

FIG. 2 is a perspective view of the TPMS testing tool of FIG. 1.

FIG. 3 is schematic diagram of the TPMS testing tool of FIG. 1.

FIG. 4 is an exploded perspective view of another embodiment TPMS testing tool.

FIG. 5 is a side view of a telescoping extender that can be used with the TPMS testing tool of FIG. 4.

FIG. 6 is a side view of a segmented extender that can be used with the TPMS testing tool of FIG. 4.

FIG. 7 is an exploded side view of a segmented extender of FIG. 6.

FIG. 8 is a side view of a folding extender that can be used with the TPMS testing tool of FIG. 4.

FIG. 9 is a side view of an alternative embodiment segmented extender that can be used with the TPMS testing tool of FIG. 3.

FIG. 10 is a perspective view of a prior art TPMS testing tool.

FIG. 11 illustrates a user holding the prior art TPMS testing tool of FIG. 10 in one hand and bending at the knees and waist in order to place the tip of the tool adjacent the tire valve and corresponding pressure sensor of a vehicle tire.

### DETAILED DESCRIPTION

The illustrated embodiments are disclosed with reference to the drawings. However, it is to be understood that the disclosed embodiments are merely intended to be examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

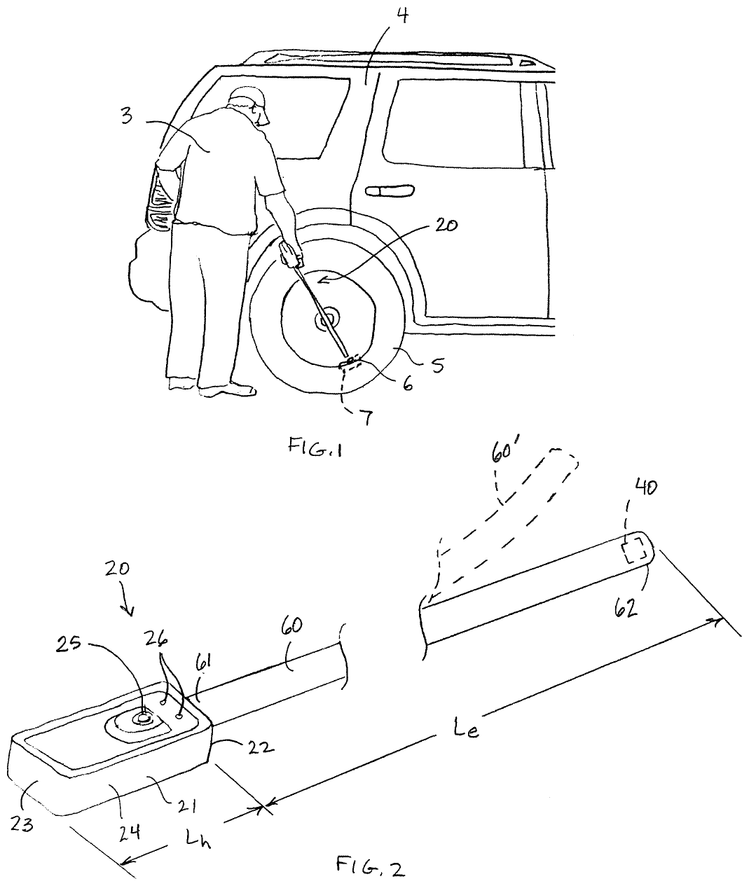

Referring to FIGS. 1-3, a TPMS testing tool 20 is configured to activate a TPM sensor 7 that is located within a tire 5 of a vehicle 4. Typically, the TPM sensor 7 is located at the air valve 6 of the tire 5. The testing tool 20 includes a housing 21 that supports an activation switch 25, a signal emitter 40, and an extender 60 disposed between the housing 21 and the signal emitter 40. The extender 60 is an elongated member that is configured to provide a predetermined spacing between the manually-actuated activation switch 25 and the signal emitter 40. In particular, the extender 60 is provided in a length that permits a user 3 that is holding the TPMS testing tool in his hand to place the signal emitter 40 of the TPMS testing tool 20 in a location closely adjacent (e.g., within in a range of 0 cm to 10 cm) of the air valve 6 of a vehicle tire 5 while permitting the user 3 to comfortably remain in an upright standing posture. As used herein, an upright standing posture refers to a stance in which the user's trunk is generally vertical and there is little or no bending of the waist and/or knees. The testing tool 20 including the extender 60 will now be described in detail.

The housing 21 includes a first end 22, a second end 23 that is opposed to the first end 22, and a sidewall 24 that extends between the first end 22 and the second end 23. In cross section, the sidewall 24 forms a closed rectangular section, and the sidewall 24 together with the first end 22 and the second end 23 define a closed generally rectangular container. The housing 21 is elongated in that the a length Lₕ of the housing 21, which corresponds to the distance between the first end 22 and the second end 23, is greater than any of the dimensions of the first and second ends 22, 23. In addition, the housing 21 is sized and shaped to be held (e.g. grasped) comfortably in one hand, and the length Lₕ of the housing 21 is generally equal to or less than to the length of an average adult male hand. In some embodiments, the length Lₕ of the housing 21 is in a range of 0.05 meters to 0.2 meters. For example, in the illustrated embodiment, the length Lₕ of the housing 21 is about 0.12 meters.

Referring to FIG. 3, a battery 27 and a printed circuit board (not shown) are enclosed within the housing 21. The printed circuit board supports an electronic control unit (ECU) 28 and various electronic components that are used to drive the signal emitter 40.

An activation switch 25 is supported on the housing. The switch 25 is a normally open on-off switch, and is manually operable to switch between an open position in which testing tool 20 is off and the signal emitter 40 is not controlled by the ECU 28 to emit the radio frequency signal, and a closed position in which the testing tool 20 is on and the signal emitter 40 is controlled by the electronic control unit to emit a radio frequency signal.

The housing 21 may also receive other devices such as light emitting diodes (LEDs) that are supported on the printed circuit board and electrically connected to the ECU 28. The LEDs serve as indicator lights that indicate, for example, when a signal is being emitted from the signal emitter 40, a low charge status of the battery 27 and/or other information.

The signal emitter 40 is disposed at a distal end 62 of the extender 60, and includes a LF coil that is electrically connected to, and driven by, the ECU 28 to emit a LF radio frequency signal having a frequency of less than about 30 MHz. For example, in some embodiments, the LF radio frequency signal emitted by the signal emitter has a frequency of 125 kHz. The LF radio frequency signal is configured to activate the TPM sensor 7 of a tire 5. To that end, the range (travel distance) of the emitted signal is relatively short. For example, in some embodiments, the signal emitter 40 is configured, for example by appropriately adjusting power, to emit a LF radio frequency signal having a maximum range of 1.0 meters. In other embodiments, the signal emitter 40 is configured to emit a LF radio frequency signal having a maximum range of 0.3 meters. In still other embodiments, the signal emitter 40 is configured to emit a LF radio frequency signal having a maximum range of 0.05 meters.

The ECU 28 may control the signal emitter 40 to provide a predetermined signal pattern, or may be switchable to permit selection of a signal pattern based on the requirements of a specific application. In the latter case, a selection switch (not shown) may be provide on the housing 21 to permit the user to select from a set of predetermined signal patterns. For example, the ECU may control the signal emitter to provide continuous wave LF signal having a predetermined duration (i.e., of at least six seconds). Alternatively, the ECU 28 may control the signal emitter 40 to provide a modulated LF signal.

The extender 60 is disposed at the first end 22 of the housing 21 and extends outward from the first end 22. The extender 60 is an elongated rod that includes a proximal end 61 that is fixed to the housing first end 22, and a distal end 62 that is opposed to the proximal end 61. The extender 60 is a single-piece tube formed of a rigid material and having a circular cross-sectional shape. The extender 60 has a closed distal end 62, and the signal emitter 40 is disposed within the hollow interior space of the extender at the distal end 62. Electrical leads (not shown) extend between the signal emitter 40 and the ECU 28. The extender 60 or the leads themselves may optionally including shielding to prevent the occurrence of electrical interference, etc. The extender 60 may be formed integrally with the housing 21, for example by molding, or may be formed separately and then fixedly connected to the housing first end 22 by conventional techniques such as via welding or adhesives.

The extender 60 has a length Lₑ that corresponds to the distance between the proximal end 61 and the distal end 62. The extender 60 provides a predetermined spacing between the activation switch 25 and the signal emitter 40. In particular, the extender length Lₑ is set so as to permit a standing, upright user 3 to hold the housing 21 in one hand and to place the signal emitter 40 at a ground-height location without requiring the user 3 to bend at the waist or knee. The ground-height location roughly corresponds to placement of a tire air valve 6 (and thus TPM sensor 7) at its lowest possible position, neglecting the tire radial dimension. To this end, for example, the extender length Lₑ may be in a range of two to twenty times the length of the housing Lₕ. In some embodiments, the length Lₑ may be in a range of three to nine times the length of the housing Lₕ. In the illustrated embodiment, the extender length Lₑ is about five times the length of the housing Lₕ.

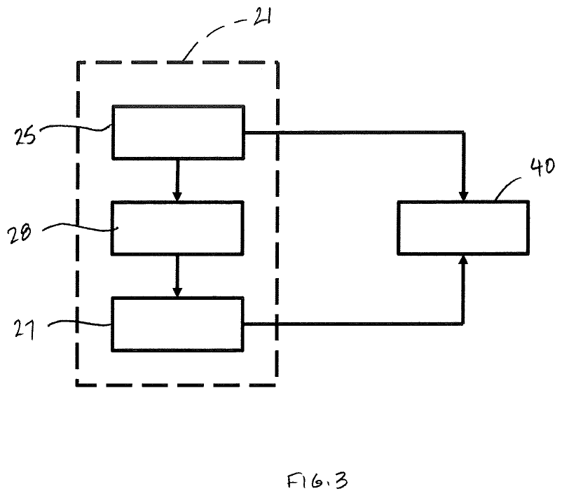

Referring to FIG. 2, the testing tool 20 may include an alternative embodiment extender 160 (shown in dashed lines) that is elastically flexible rather than rigid. The elastic flexibility of the generally rod-shaped extender 160 may be achieved by using appropriate materials, by employing structural elements to facilitate elastic flexibility, or a combination thereof In one example (not shown), the extender 160 is a generally rigid rod that is connected to the housing first end via a short segment of coiled spring. In another example (not shown), the extender 160 includes a coiled spring core that extends between the proximal and distal ends 61, 62 of the extender 160. The coiled spring core may be coated with a flexible material.

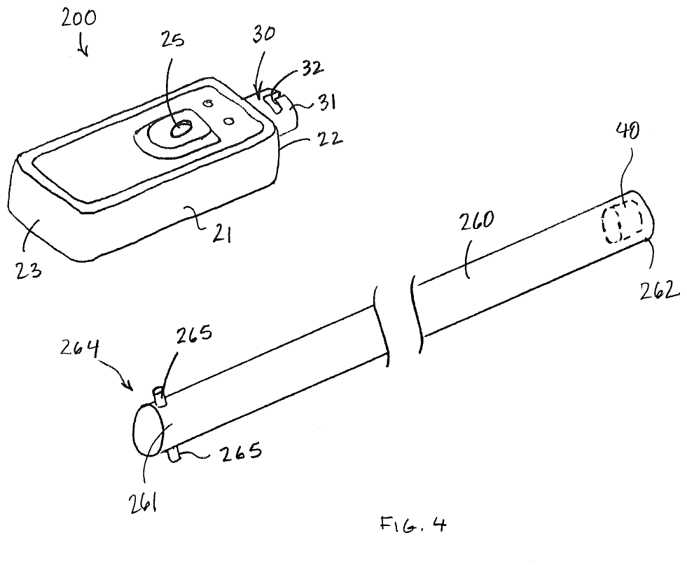

Referring to FIG. 4, an alternative embodiment testing tool 220 is similar to the testing tool 20 described above with respect to FIGS. 1-3. For this reason, common elements are referred to with common reference numbers and the description of common elements is not repeated. The alternative embodiment testing tool 220 differs from the earlier described embodiment in that the proximal end 261 of the extender 260 is selectively detachable from the housing first end 22. In particular, the housing first end 22 includes a first connector portion 30 that is configured to engage with a corresponding second connector portion 264 disposed on the extender proximal end 261, whereby the detachable extender 260 can be secured to the housing 21. For example, in the illustrated embodiment, the extender 260 may be selectively detachable from the housing first end 22 via a bayonet connection. The bayonet connection includes the first connector portion 30 which is a sleeve 31 that protrudes from the housing first end 22. The sleeve 31 formed have curved slots 32 that open at a free end of the sleeve 31. The second connector portion 264 includes a pair of pins 265 that protrude radially from an outer surface of the extender proximal end 261. The slots 32 are configured to receive and engage with the pins 265, whereby the extender 260 may be retained on the housing 21.

It is understood that the bayonet connection is an exemplary embodiment, and that other connection methods may be used to detachably secure the extender 260 to the housing 21, including for example, press fitting or a screw-thread connection, and thus the first connector portion 30 and the second connector portion 264 may have other forms appropriate to the connecting method.

Referring to FIG. 5, the testing tool 20, 220 may include an alternative embodiment extender 360 in which the length of the extender 360 is adjustable. The adjustable length extender 360 includes a proximal end 361 that connects to the housing first end 22, and an opposed distal end 362 that houses the signal emitter 40 (not shown in this view). In the illustrated embodiment, the adjustable length extender 360 is formed having several tubular segments 366a, 366b, 366c, 366d. The tubular segments 366a, 366b, 366c, 366d differ in diameter in a serially stepwise manner, are coaxially arranged and have ends that are serially connected in such a way that the segments 366a, 366b, 366c, 366d telescope relative to each other. In the illustrated embodiment, the relative axial position of one segment (i.e., segment 366b) relative to the adjacent segment (i.e., segment 366c) is maintained via a friction fit connection. Although four segments 366a, 366b, 366c, 366d are illustrated, the number of segments employed may be fewer or greater, and will depend on the requirements of the specific application.

It is understood that the telescoping adjustable length extender 360 is an exemplary embodiment, and that other methods and/or structures may be used to provide an adjustable length extender.

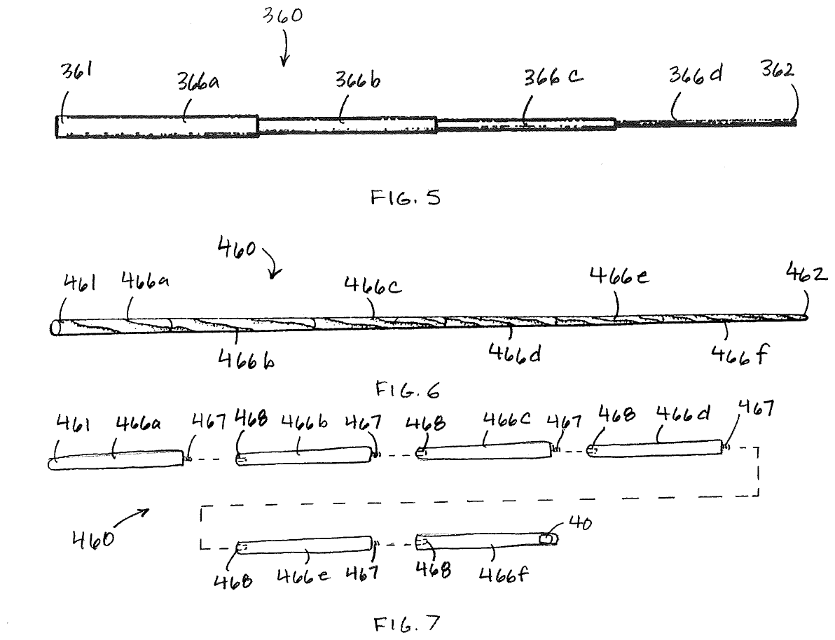

Referring to FIGS. 6 and 7, the testing tool 20, 220 may include an alternative embodiment extender 460 in which the extender 460 is formed of individual cylindrical segments 466a, 466b, 466c, 466d, 466e, 466f that are configured to be assembled end-to-end to form an elongated rod. The segmented extender 460 includes a proximal end 461 that connects to the housing first end 22, and an opposed distal end 462 that houses the signal emitter 40 (FIG. 7). The individual cylindrical segments 466a, 466b, 466c, 466d, 466e are coaxially arranged and have ends that are serially connected in such a way that the segments 366a, 366b, 366c, 366d are rigidly fixed relative to each other. For example, in the illustrated embodiment, one segment (i.e., segment 466c) includes an axially-extending threaded protrusion 467 that engages corresponding threads formed in an axially-extending opening 468 of an adjacent segment (i.e., segment 466d). Although six segments 466a, 466b, 466c, 466d, 466e, 466f are illustrated, the number of segments employed may be fewer or greater, and will depend on the requirements of the specific application.

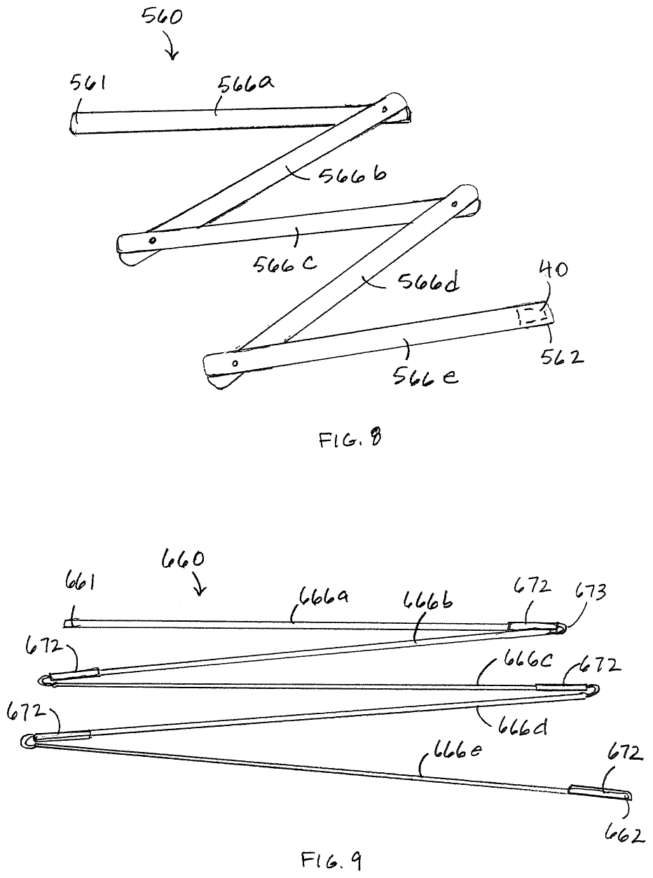

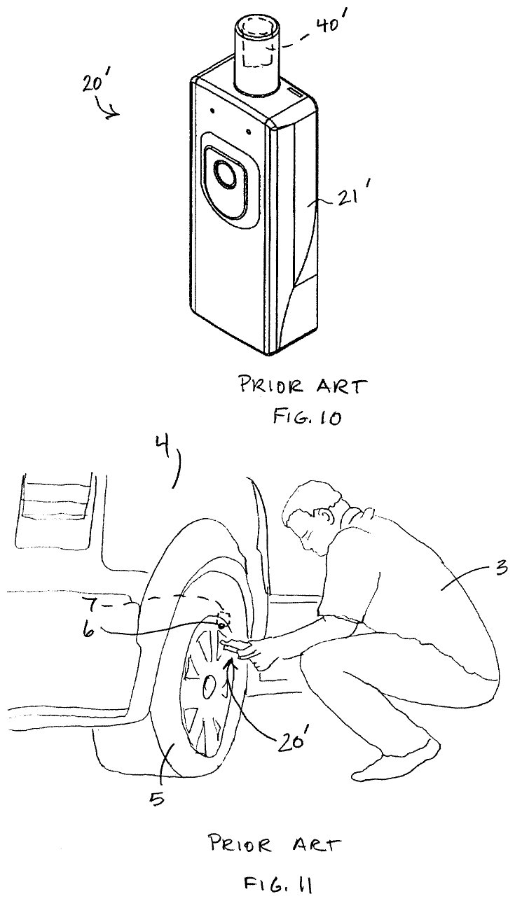

Referring to FIG. 8, it is understood that the segmented extender 460 employing threaded interconnecting segments is an exemplary embodiment, and that other methods and/or structures may be used to provide a segmented extender. For example, in an alternative embodiment segmented extender 560, five individual segments 566a, 566b, 566c, 566d, 566e are assembled end-to-end via a flexible connection to form an elongated rod. The segmented extender 560 includes a proximal end 561 that connects to the housing first end 22, and an opposed distal end 562 that houses the signal emitter 40. The individual segments 566a, 566b, 566c, 566d, 566e have ends that are serially connected using pins 569 such that the segments 566a, 566b, 566c, 566d, 566e may pivot relative to each other about an axis transverse to an axis defined by the fully extended extender 566. For example, in the illustrated embodiment, one segment (i.e., segment 566c) is connected at one end via the pin 569 to an adjacent end of an adjacent segment (i.e., segment 566d). The relative angular position of the individual segments 566a, 566b, 566c, 566d, 566e relative to the adjacent segment is maintained via a frictional fit between the corresponding pin 569 and the respective segments that the pin connects. In use, the extender 566 may take on and maintain various shapes by appropriately positioning each segment relative to the adjacent segment. Moreover, some the interconnected segments 566a, 566b, 566c, 566d, 566e may be fully folded about the corresponding pins 569 while others are fully extended to provide an adjustable length extender 460. In addition, all the interconnected segments 566a, 566b, 566c, 566d, 566e may be fully folded about the pins 569 to provide a compact arrangement for storage of the extender 460. Although five segments 566a, 566b, 566c, 566d, 566e are illustrated, the number of segments employed may be fewer or greater, and will depend on the requirements of the specific application.

Referring to FIG. 9, in another alternative embodiment segmented extender 660, five individual tubular segments 666a, 666b, 666c, 666d, 666e are assembled end-to-end via a flexible connection to form an elongated rod. The segmented extender 660 includes a proximal end 661 that connects to the housing first end 22, and an opposed distal end 662 that houses the signal emitter 40 (not shown). The individual segments 666a, 666b, 666c, 666d, 666e have ends that are serially connected using a collar 672 at one end of each segment that is dimensioned to receive an end of the adjacent segment. In addition, an elastic cord 673 extends within the tubular segments between the extender proximal end 661 and the extender distal end 662. The cord 673 is tensioned such that when the segments 666a, 666b, 666c, 666d, 666e are assembled and interconnected end to end, the cord 673 applies an axial compressive force that retains one end of one segment (i.e. segment 666c) within the collar 672 of an adjacent segment (i.e., segment 666d). When unassembled, the segments 666a, 666b, 666c, 666d, 666e remain interconnected by the cord 673, but may be folded relative to each other to provide a compact arrangement for storage of the extender 660. Although five segments 666a, 666b, 666c, 666d, 666e are illustrated, the number of segments employed may be fewer or greater, and will depend on the requirements of the specific application.

In some aspects, the testing tool 220 may be assembled with two or more detachable extenders 160, 260, 360, 460, 560, 660 into a kit, where each extender within the kit is different from the other extenders within the kit with respect to one or more features such as shape, size, flexibility, material, etc. Such a kit would permit a user 3 who works in a service center to use the same testing tool 220 with one of the extenders from the selection provided by the kit in order to activate TMP sensors on a wide variety of types of vehicles and/or wheel configurations. In addition to the testing tool 220 and two or more extenders, the kit may also include a storage case, a battery charger and/or other ancillary devices and features.

Although the housing 21 is described as being generally rectangular in shape, the housing 21 is not limited to this configuration. For example, the housing may be ovoid, T-shaped or other shape as determined by the requirements of the specific application.

Although the extender and/or individual segments that are assembled to form an extender are described as having a circular cross-sectional shape, the extender and/or segments are not limited to this shape. The cross-sectional shape is determined by the requirements of the specific application, and may alternatively have, for example, a rectangular shape or an irregular shape.

In the illustrated embodiment, the signal emitter 40 includes a LF coil that is electrically connected to, and driven by, the ECU 28 to emit a LF radio frequency signal having a frequency of less than about 30 MHz. It is understood, however, that the signal emitter may emit signals in another frequency range. It is also understood, that instead of an LF coil, the signal emitter 40 may use another type of signal generator or exciter. For example, the signal emitter may be a magnet that generates a predetermined magnetic field, or other type of exciter.

Although the illustrated embodiments show a TPMS testing tool 20 in which the housing 21 including the activation switch 25, the ECU 28 and the driving electronics is disposed at one end of the testing tool 20 and the signal emitter 40 is disposed at an opposed end of the testing tool 20, the testing tool 20 is not limited to this configuration. For example, it is contemplated that alternative embodiments of the testing tool may include the housing 21 including the ECU and driving electronics disposed at an intermediate location between the ends of the testing tool, or disposed at the opposed end of the testing tool (e.g. at the distal end of the extender 60). In such alternative embodiments, the activation switch 25 remains disposed at the one end of the testing tool for convenient access by the user, and the signal emitter 40 remains disposed at the opposed end of the testing tool to maximize the reach of the testing tool.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

1. A tire pressure monitoring system testing tool that comprises
a housing including a first end, a second end opposed to the first end, and a sidewall that extends between the first end and the second end, the sidewall together with the first end and the second end defining a closed container, the distance between the first end and the second end corresponding to a length of the housing,
an extender that protrudes from the first end, the extender including a proximal end connected to the first end and a distal end opposed to the proximal end, the distance between the proximal end and the distal end corresponding to a length of the extender,
a signal emitter disposed in the distal end of the extender, the signal emitter configured to emit a radio frequency signal,
an electronic control unit disposed in the testing tool, and
a manually-operated activation switch that is supported on the sidewall and permits activation of the signal emitter,
wherein the length of the extender is in a range of two to twenty times the length of the housing.

2. The tire pressure monitoring system testing tool of claim 1, wherein the length of the extender is adjustable.

3. The tire pressure monitoring system testing tool of claim 1, wherein the extender is formed of individual segments that are configured to telescope with respect to one another.

4. The tire pressure monitoring system testing tool of claim 1, wherein the extender is formed of individual segments that are configured to be assembled end-to-end to form an elongated rod.

5. The tire pressure monitoring system testing tool of claim 1, wherein the extender is formed of individual segments that are configured to be assembled end-to-end to via a pivoting connections to form an elongated rod.

6. The tire pressure monitoring system testing tool of claim 1, wherein the extender is a unitary flexible and elastic rod.

7. The tire pressure monitoring system testing tool of claim 1, wherein the proximal end of the extender is formed integrally with the housing first end.

8. The tire pressure monitoring system testing tool of claim 1, wherein the proximal end of the extender is connected to the housing first end via a detachable connector.

9. The tire pressure monitoring system testing tool of claim 1, wherein the proximal end of the extender is connected to the housing first end via a bayonet connector.

10. The tire pressure monitoring system testing tool of claim 1, wherein the proximal end of the extender is connected to the housing first end via a screw thread connection.

11. The tire pressure monitoring system testing tool of claim 1, wherein the signal emitter comprises a low frequency coil that is electrically connected to, and controlled by, the electronic control unit.

12. The tire pressure monitoring system testing tool of claim 1, wherein the signal emitter is configured to emit a radio frequency signal of less than 30 MHz.

13. The tire pressure monitoring system testing tool of claim 1, wherein the signal emitter is configured to emit a radio frequency signal having a maximum range of 0.3 meters.

14. A tire pressure monitoring system testing tool that includes
a housing that is dimensioned to be held in a hand of a user,
an extender that protrudes from the housing, the extender including a proximal end that is detachably connected to an end of the housing and a distal end opposed to the proximal end,
a signal emitter disposed in the distal end of the extender, the signal emitter configured to emit a radio frequency signal of less than 30 MHz,
an electronic control unit disposed in the testing tool, and
a manually-operated activation switch that is supported on a side of the housing and permits activation of the signal emitter,
wherein the extender is configured to permit a standing, upright user to hold the housing in one hand and to place the signal emitter at a ground-height location without requiring the user to bend at the waist or knee.

15. The tire pressure monitoring system testing tool of claim 14, wherein the distance between the proximal end and the distal end corresponds to a length of the extender, and the length of the extender is adjustable.

16. The tire pressure monitoring system testing tool of claim 14, wherein the extender is formed of individual segments that are configured to telescope with respect to one another.

17. The tire pressure monitoring system testing tool of claim 14, wherein the extender is formed of individual segments that are configured to be assembled end-to-end to form an elongated rod.

18. The tire pressure monitoring system testing tool of claim 14, wherein the proximal end of the extender is connected to the housing first end via a detachable connector.

19. A tire pressure monitoring system testing tool kit that includes
a housing that is dimensioned to be held in a hand of a user,
a first extender including a proximal end that is configured to be detachably connected to an end of the housing and a distal end opposed to the proximal end,
a second extender including a proximal end that is configured to be detachably connected to an end of the housing and a distal end opposed to the proximal end, the second extender being different from the first extender in one or more of shape, size, flexibility and material,
a signal emitter disposed in the distal end of each of the first extender and the second extender, the signal emitter configured to emit a radio frequency signal of less than 30 MHz,
an electronic control unit disposed in the testing tool, and
a manually-operated activation switch that is supported on a side of the housing and permits activation of the signal emitter,
wherein the first extender and the second extender are each configured to permit a standing, upright user to hold the housing in one hand and to place the signal emitter at a ground-height location without requiring the user to bend at the waist or knee.

20. (canceled)
